(19) United States
(12) Patent Application Publication
(10) Pub. No.: US 2020/0018092 A1
(43) Pub. Date: Jan. 16, 2020

(54) DOOR CLOSURE NOISE DAMPENING SYSTEM WITH AUTO DEADBOLT DOOR LOCK

(71) Applicant: QUIET SOURCE TECHNOLOGIES, LLC, Manchester, NH (US)

(72) Inventors: Joseph J. Schappler, Bedford, NH (US); Kevin McKowen, Bedford, NH (US); Alan K. Stratton, Milford, NH (US); David Carpenter, Jaffrey, NH (US)

(21) Appl. No.: 16/003,299

(22) Filed: Jun. 8, 2018

Related U.S. Application Data
(60) Provisional application No. 62/517,547, filed on Jun. 9, 2017.
(60) Provisional application No. 62/537,518, filed on Jul. 27, 2017.

(51) Int. Cl. E05B 17/00; E05B 15/02; E05B 9/02

(52) U.S. Cl. CPC E05B 17/0045; E05B 15/022; E05Y 2800/422; E05Y 2900/132; E05B 9/02

(57) ABSTRACT

A system for ensuring that a door automatically closes and latches while simultaneously ensuring that it does so in a manner which either eliminates or significantly minimizes the amount of noise such closure causes while making sure that the door does in fact fully close and latch. A door mounted portion includes a piston attached to a pivotable arm having a wheel on the end of the arm configured to engage with a doorframe mounted portion to slow the travel of the door into the doorframe while pulling the door into the doorframe to ensure secure closure of the door. A doorframe mounted striker plate portion is configured with at least one spring-loaded striker damper or flap against which a door latch and/or automatically deploying deadbolt lock engages, to slow the engagement of the door latch or deadbolt with striker region in the frame to minimize noise.

### CROSS-REFERENCE TO RELATED APPLICATIONS

This application claims priority from U.S. Provisional Patent Application No. 62/517,547 filed on Jun. 9, 2017 and titled “DOOR CLOSURE NOISE DAMPENING SYSTEM” and U.S. Provisional Patent Application No. 62/537,518 entitled “DOOR CLOSURE NOISE DAMPENING SYSTEM WITH AUTO DEADBOLT DOOR LOCK” filed on Jul. 27, 2017, both of which are incorporated fully herein by reference.

### TECHNICAL FIELD

The present invention relates to automatically closing commercial doors such as found in hotel rooms and office buildings and more particularly, relates to a three-piece door closing and dampening system designed to eliminate and/or significantly minimize the amount of noise caused by a door closed by a manually or automatically driven door closer and to an auto deadbolt receiving striker plate.

### BACKGROUND INFORMATION

There are many instances where automatic door closing systems are utilized on and in connection with commercial doors to ensure that doors close and sometimes lock for personal safety and/or fire considerations. For example, hotels utilize automatic door closing systems to ensure the safety of its patrons by making sure the door closes and locks when the patron enters and/or exits their hotel room. Hotel room doors are typically heavy wood or steel doors while the door frames are typically hollow metal frames mounted in hollow walls having an occasional metal divider stud.

There are many door closure mechanisms including closure mechanisms mounted in the door hinges as well as surface mounted piston or spring actuated closure mechanisms.

The automatic closure mechanisms on such doors are typically adjusted to guarantee that the door will close despite any potential wind blowing from the hotel hallway through the room. Accordingly, the adjustment is typically set to overcompensate for those situations when there is no force keeping the door from closing and thus, because of the force exerted by the automatic door closure mechanism on the door causing it to slam against the metal frame; and further, because of the sudden release of the door latch into the metal latch striker plate in the metal frame, a significant amount of noise is generated when such doors close and latch.

Such noise may not be a factor in commercial or industrial settings however, such a door closure at 2 AM in a hotel setting can disrupt the sleep of individuals in one or more adjoining rooms, much to the displeasure of those individuals.

An additional source of noise in such commercial doors is the deployment of an automatic deadbolt that automatically deploys when the door is proximate the metal doorframe and striker plate. There are two major contributors to the sound made by the automatic deadbolt when the releases as the door is closing and over which there is some control. The first contributing factor is the gap or space between the door edge and the doorframe. The automatic deadbolt a spring-loaded to deploy outward, away from the door, and contact the leading edge of the striker plate and ultimately penetrate the striker plate and lock upon closure of the door.

Generally speaking, the automatic deadbolt is held flush with the edge of the door by a feature which releases it when the door is almost closed, and after a trigger has been activated. Because the deadbolt a spring-loaded, once it is released it is subjected to a force in the outward direction. This force can, for purposes of discussion, be considered constant over the range of motion of the deadbolt (however in practice it actually declines slightly as the deadbolt travels outward).

The laws of physics teach that a mass, in this case the deadbolt, which is subjected to an (approximately) constant force accelerates as a result of that force. A key feature of acceleration is that the velocity of the mass increases with both time and distance. Therefore, the wider the gap between the door edge and the doorframe, the farther the deadbolt travels and hence the faster it is going when it makes contact with the leading edge of the striker plate. The volume of the sound made when the automatic deadbolt makes contact with the striker plate is proportional to the velocity at which it is traveling and hence to the gap between the door edge and the doorframe.

The second factor contributing to noise with the automatic deadbolt is the material with which the deadbolt first makes contact after release. This material influences the volume and character of the sound that is generated. For example, the deadbolt (metal) striking the bare metal striker plate makes a loud, sharp noise. If the material to be contacted by the deadbolt is plastic, for example, the sound is reduced and is also made to be less jarring. Even softer materials such as rubber further lesson the volume and sharpness of the noise.

Accordingly, what is needed is a system for ensuring that a door automatically closes and latches and that the automatic deadbolt, if present, engages while simultaneously ensuring that it does so in a manner which either eliminates or significantly minimizes the amount and character of noise such automatic closure and automatic deadbolt release causes while making sure that the door does in fact fully close and latch.

### SUMMARY

The present invention features a door closure noise dampening system comprising a door mounted noise dampening closure portion and a doorframe mounted noise dampening closure portion. The doorframe mounted noise dampening closure portion is configured for receiving a portion of the door mounted noise dampening closure portion. A doorframe mounted striker plate portion is configured for receiving a door mounted door lock latch.

The door mounted noise dampening closure portion includes a pivotable arm portion that is movable between a first armed position, configured for coming into contact with the doorframe mounted noise dampening closure portion, and a second engaged position, configured for engaging with the doorframe mounted noise dampening closure portion.

The pivotable arm portion includes a rotatable element disposed on a distal end of the pivotable arm portion while the proximal end of the pivotable arm portion of the door mounted noise dampening closure portion is coupled to a piston.

The doorframe mounted noise dampening closure portion includes a first tab and a second tab generally parallel to the first tab, the first tab configured for engaging with the rotatable element disposed on the distal end of the pivotable arm portion, and configured for causing the piston coupled to the proximal end of the pivotable arm portion to move from the armed position to the engaged position by causing the rotatable element to travel upward along first tab in a controlled manner when a door on which the door mounted noise dampening closure portion is mounted is moved from a first open position to a second closed position. The second tab is configured for engaging with the rotatable element when the door on which the door mounted noise dampening closure portion is mounted is moved from the second closed position to the first open position thereby causing the pivotable arm portion to move from the second engaged position to the first armed position.

The doorframe mounted striker plate portion includes a striker plate damper element movable from a first at rest position to a second engaged position upon pressure of a door lock latch engaging with the striker plate damper element, and wherein the striker plate damper element is coupled to a spring and configured for providing resistance of movement of the striker plate damper element from the at rest position to the engaged position.

### BRIEF DESCRIPTION OF THE DRAWINGS

These and other features and advantages of the present invention will be better understood by reading the following detailed description, taken together with the drawings wherein:

FIG. 1 is a plan view diagram of a door installed in a doorframe including the door closure noise dampening system according to the present invention;

FIG. 2 is a close-up of the door mounted noise dampening closure portion of the present invention mounted on the door and the door frame mounted closure noise dampening receiver portion mounted on the doorframe;

FIG. 3 is a close-up of the doorframe mounted closure noise dampening receiver portion of the present invention;

FIGS. 4A and 4B are schematic diagrams of the door mounted noise dampening closure portion of the present invention in engaged and disengaged positions respectively;

FIG. 5 is a diagram of the door mounted noise dampening closure portion of the present invention mounted on a door in a pre-engagement position and illustrating a cover which may be mounted on the noise dampening closure portion as well as the doorframe mounted receiver portion;

FIG. 6 is a front schematic view of the doorframe mounted striker plate according to one feature of the present invention;

FIG. 7 is a front view close-up schematic view of a portion of the doorframe mounted striker plate illustrating the striker plate travel limiting member according to one feature of the present invention;

FIG. 8 is a back and top schematic view of a portion of the doorframe mounted striker plate according to this feature of the present invention;

FIG. 9 is a back and side schematic perspective view of a portion of the doorframe mounted striker plate showing the damping or flap member in the open position engaged with a door latch and deadbolt

FIG. 10 is a front side view of a doorframe mounted striker plate with the automatically deploying deadbolt damper in accordance with one feature of the present invention;

FIG. 11 is a rear view of a doorframe mounted striker plate with the automatically deploying deadbolt damper in accordance with this feature of the present invention;

FIG. 12 is a close-up rearview of the doorframe mounted striker plate with the automatically deploying deadbolt damper showing the damper spring in accordance with this feature of the present invention; and

FIG. 13 is a side cutaway view of a doorframe and which is mounted a striker plate with automatically deploying deadbolt damper in accordance with one feature of the present invention and illustrating the automatically deploying deadbolt in place in the striker plate/doorframe.

### DETAILED DESCRIPTION OF THE PREFERRED EMBODIMENTS

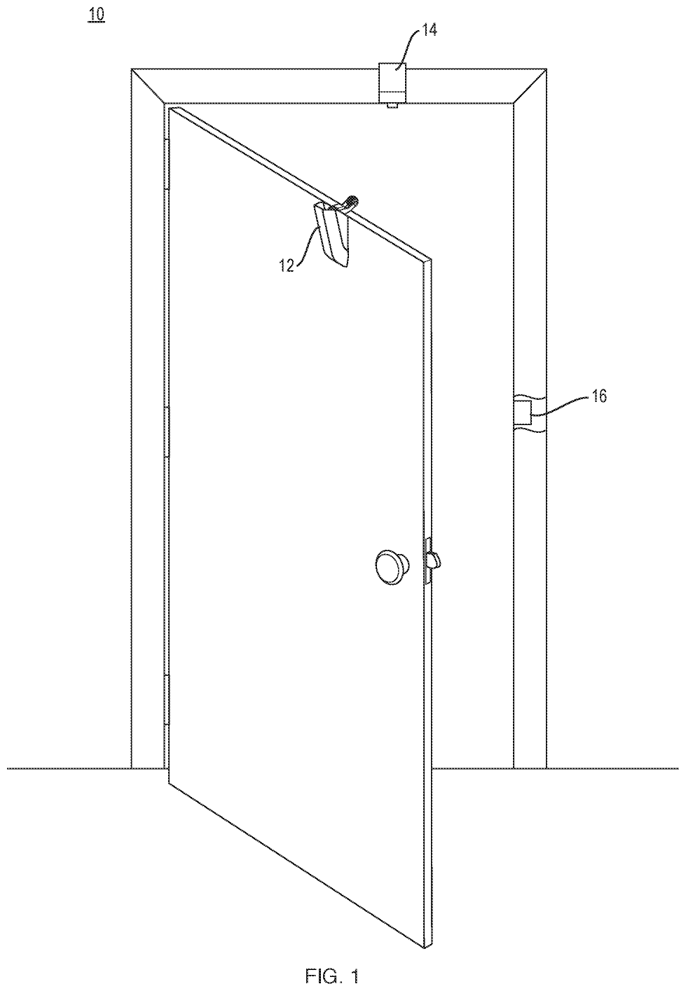

The present invention features a door closure noise dampening system configured for being installed on a door and illustrated generally at 10, FIG. 1. The system 10 includes, in the preferred embodiment, 3 portions including: a door mounted noise dampening closure portion 12; a door frame mounted noise dampening receiver portion 14 and a door frame mounted striker plate portion 16. The doorframe mounted striker plate portion 16 may be utilized stand-alone, without the door mounted noise dampening closure portion 12 and/or the doorframe mounted noise dampening receiver portion 14, although all 3 system portions work together to provide all of the essential features required in an attempt to ensure quiet door closure and automatic latching.

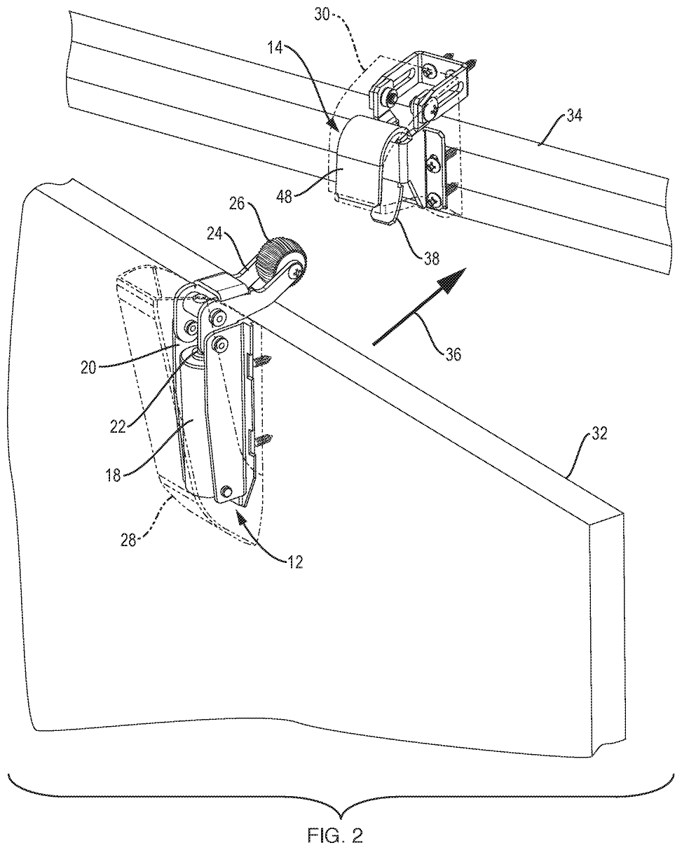

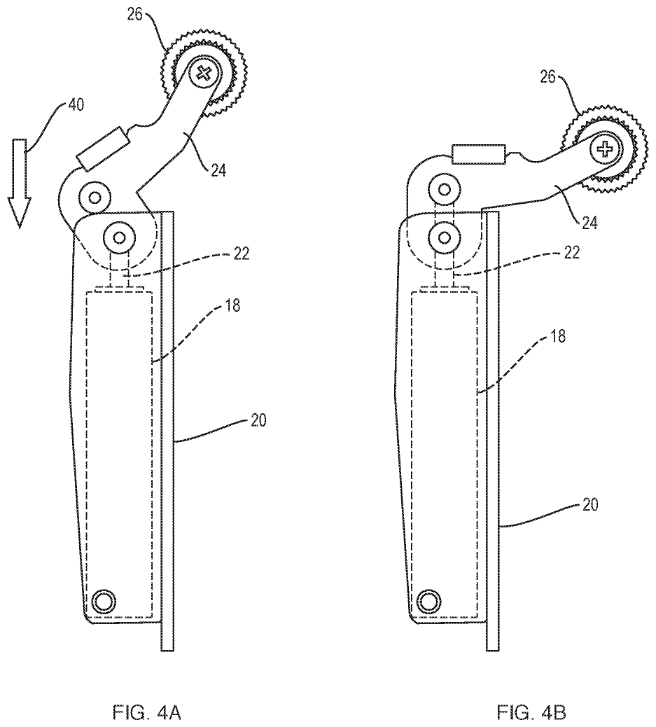

A first portion of the door closure noise dampening system 10 according to the teachings of the present invention is the door mounted noise dampening portion 12, FIG. 2 and FIGS. 4A and 4B. The door mounted noise dampening portion 12 includes a piston 18 mounted in a bracket 20. A piston rod 22 is coupled to a movable arm portion 24 which includes, proximate an end region, a rotatable wheel 26. The movable arm portion 24 can be provided in several lengths, if required, to account for various door thicknesses.

The movable arm portion 24 is movable between a first position (shown in FIGS. 2 and 4B) in which the movable arm portion is shown “armed” but not engaged with the doorframe mounted noise dampening receiver portion 14, and a second, engaged position (shown in FIG. 4A) in which the movable arm portion 24 is in a generally upright position with the wheel 26 engaged with the doorframe mounted noise dampening receiver portion 14 (as will be described in greater detail below). For aesthetic purposes, plastic covers 28 and 30 may be provided over the door mounted noise dampening portion 12 and the doorframe mounted noise dampening receiver portion 14 respectively.

In use, an automated door closure mechanism mounted on the door (and not part of the invention) urges the door 32 toward the frame 34 as shown in the direction of arrow 36 until the wheel 26 on the door mounted portion 12 engages with a first tab 38 on the doorframe mounted noise dampening receiver portion 14. The force of the closing door in the direction of arrow 36 causes the wheel 26 to engage with the first tab 38 which triggers the release of the piston rod 22 previously held in the position shown in FIG. 4B causing the piston rod 22 to be slowly drawn downward as shown in the direction of arrow 40 causing wheel 26 to ride upward along first tab 38 in a controlled manner. This action causes the door 32 to lose momentum and to be slowly drawn inward toward the doorframe 34 until the door latch engages with the door latch striker in the frame.

The automatic door closure mechanism, which is not shown and not part of the invention, exerts the necessary closing force on the door to ensure that the door closes until such time as the wheel 26 engages with the doorframe mounted noise dampening receiver portion 14 which serves to both slow the movement of the door towards the doorframe 34 while at the same time slowly and in a controlled manner pulling the door 32 into position against the doorframe 34.

When the door is opened, the wheel 26 from the door mounted noise dampening portion 12 which has previously come to rest between the first tab 38 and the second tab 48 on the doorframe mounted noise dampening receiver portion 14 is reset into the position shown in FIG. 4B by the action of the wheel 26 hitting against the second tab 48 thus preparing the door mounted noise dampening portion 12 of the present invention for reuse.

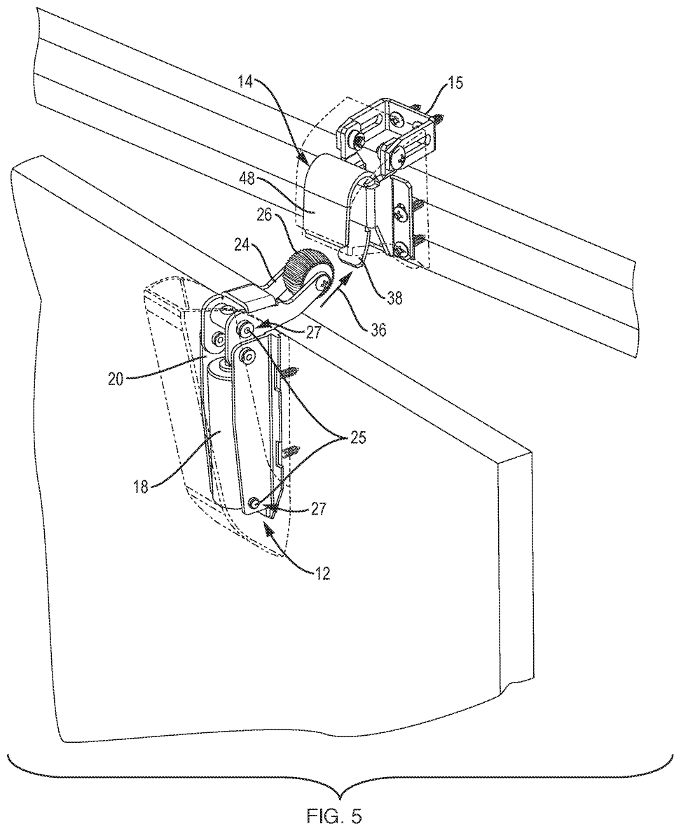

As shown in FIG. 5, the piston 18 of the door mounted noise dampening portion 12 is mounted to the bracket 20 using various rods/bolts 25 which may be held in place using standard c-clips 27 which serve to ensure axial stability for all pivoting members.

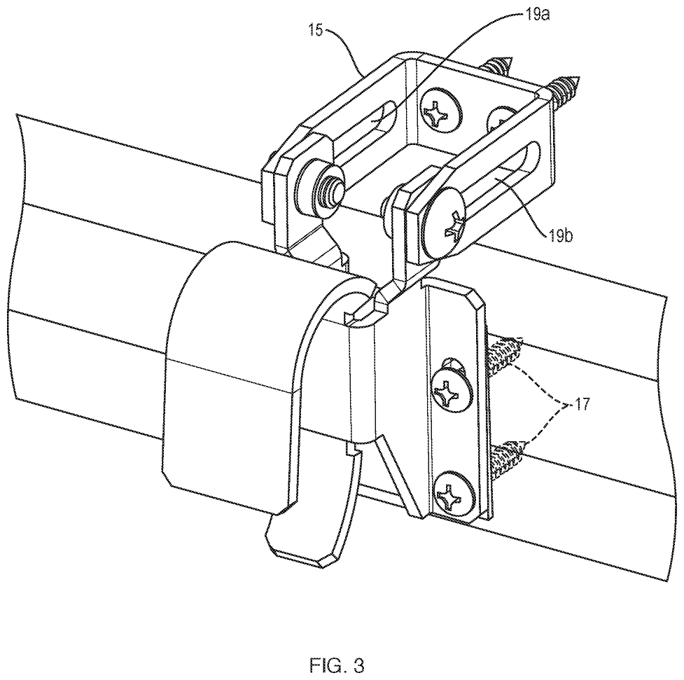

The doorframe mounted noise dampening receiver portion 14 is adjustable based on door thickness and frame thickness. The doorframe mounted noise dampening receiver portion 14 may experience significant forces when impacted by the rubber roller 26 during door closing. The doorframe mounted noise dampening receiver portion 14 therefore incorporates an optional support bracket 15, FIG. 3 attaches directly to the wall above the frame, rather than to the frame. This provides a fastening point far from the fasteners 17 attaching the doorframe mounted noise dampening receiver portion 14 to the doorframe, and substantially reinforces the doorframe mounted noise dampening receiver portion 14 against the impact experienced during door closing.

Because frame thickness also varies and in some cases the frame may be flush to the wall, the bracket 15 allows for connection between the wall and the doorframe mounted noise dampening receiver portion 14 over a wide range of frame thicknesses. This is accomplished through the use of slots 19 that allow the affixing of fasteners at any position along their lengths. The bracket 15 therefore allows the doorframe mounted noise dampening receiver portion 14 to be secured directly to a wall area adjacent the door frame 34 to more securely fasten and hold the doorframe mounted noise dampening receiver portion 14 in place.

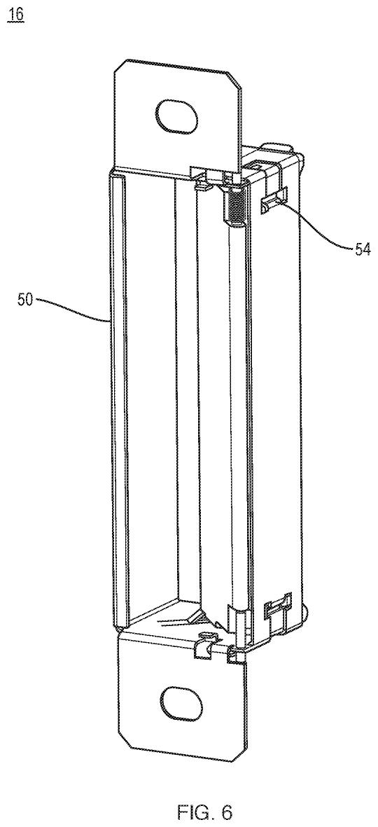

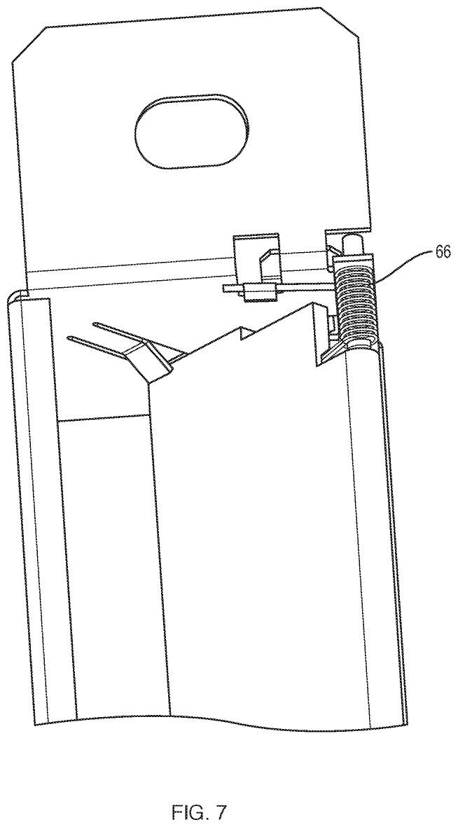

Another feature of the present invention is the door mounted striker plate 16 shown in FIGS. 6 through 9. Because a door latch engaging with a standard door latch striker region in a hollow doorframe create so much noise, the present invention includes, in one feature, the spring activated striker plate 16. The striker plate 16 is designed and configured to fit in a similarly sized opening that currently exists in a doorframe and adapted to receive a standard striker receiver plate.

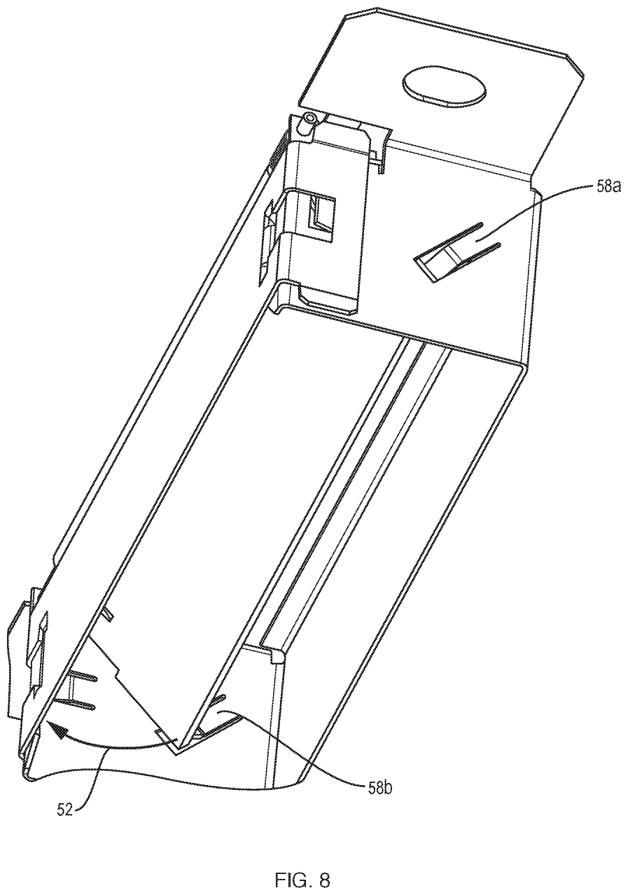

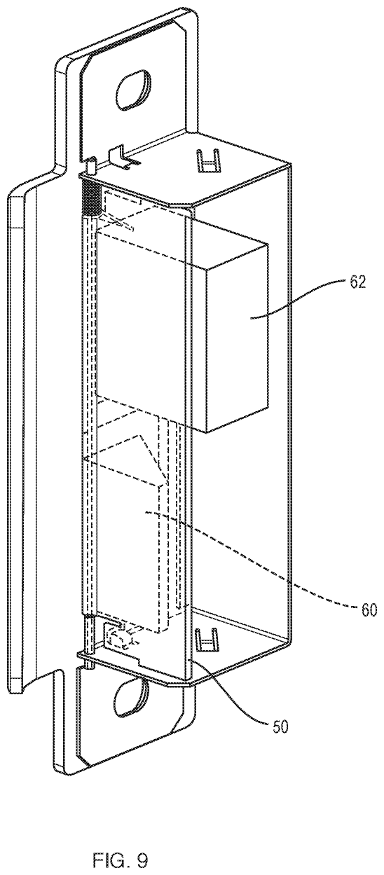

The striker plate 16 according to this feature of the invention includes a spring-loaded movable flap or damper 50 which is designed and configured to move between the at rest position shown in FIG. 6 and an engaged position shown in FIG. 9, wherein the spring-loaded movable plate 50 is pushed by a door lock latch 60 or deadbolt 62 in the direction of arrow 52, FIG. 8. The spring-loaded movable plate 50 is held under tension of spring 54 such that when the door lock latch 60 begins to engage with it, the resistance of the spring 54 causes the spring-loaded movable plate 50 to provide some resistance against the door latch 60 thus ensuring that the door latch 60 does not quickly and loudly come to position inside a hollow door latch receiver or doorframe.

The doorframe mounted striker plate portion 16 may include first and second tabs 58a and 58b which serve to limit how far the spring loaded movable striker plate 50 returns to a fully non-engaged position. The tabs 58a and 58b keep the spring-loaded movable plate 50 at approximately 45° angle when the door is opened. This starting angle of the spring-loaded movable plate 50 is designed to achieve a balance between the starting angle of the spring-loaded movable striker plate 50 and the strength of the torsion springs 66 which bias the spring-loaded movable plate 50 to achieve the best damping effect while still ensuring that the door latch Paul 60 seats fully in the frame pocket for security reasons. Through trial and error, applicant has discovered that an initial angle for the spring-loaded movable plate 50 is better than having the spring-loaded movable plate 50 parallel to the front surface or plane of the doorframe mounted striker plate portion 16.

The doorframe mounted striker plate portion 16 does allow a very small amount of noise from the door latch 60 which provides an audible indication to a person in the room or exiting the room that the door has in fact closed and latched. However, the level of noise is significantly reduced from that of prior art door lock laches engaging in the doorframe striker region.

Accordingly, the 3 pieces of the present invention namely, the door mounted noise dampening portion in combination with the doorframe mounted noise dampening receiver portion work together to quietly guide the door to which is attached an automated door closure mechanism into a fully closed position while minimizing the speed of the closure at the very last minute when the door is nearing contact with the doorframe. These 2 portions may be utilized alone without the doorframe mounted striker dampener portion. However, the doorframe mounted striker dampener portion may be utilized either alone or in combination with the door dampening portions to provide a truly quiet and essentially nearly noise less door closure and latching.

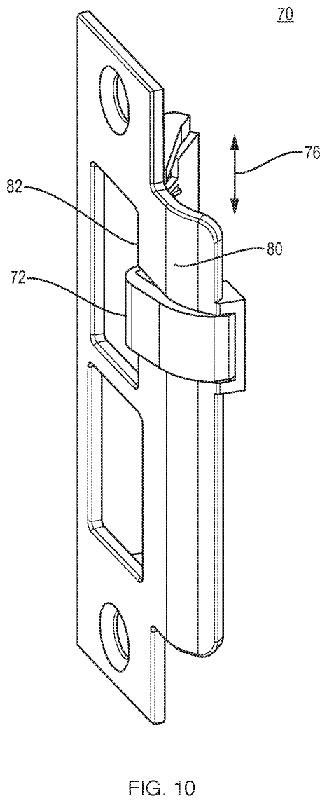

Another feature of the present invention which can be used either alone or in combination with the earlier described in 3 pieces of the present invention is a striker plate 70, FIG. 10, including damper element 72. Damper element 72 will be made from a material which is softer than the striker plate such as plastic or rubber. The damper 72 must be rigid enough to act is a mechanical component but must also exhibit a sliding force applied in both directions as the door is opened and closed. A lubricious, sturdy material such as Polyoxymethylene (POM), also known as acetal, polyacetal and polyformaldehyde (available commercially under the brand name Delrin), is an engineering thermoplastic used in precision parts requiring high stiffness, low friction, and excellent dimensional stability.

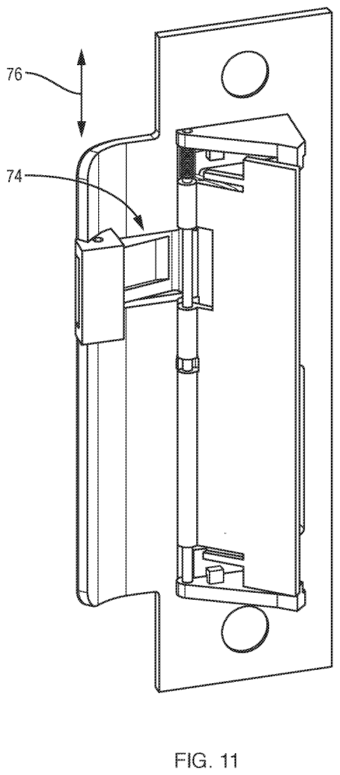

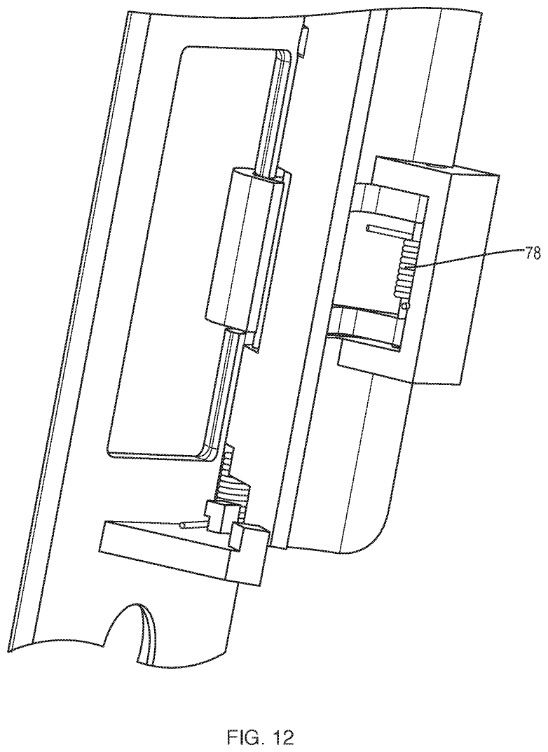

The damper 72 is located in a cut out 74, FIG. 11, and pivots about axis 76 while under spring tension effectuated by spring 78, FIG. 12. The damper 72 is designed to protrude outwardly approximately 0.180 inches from the front surface 80 of the striker plate 70. The damper 72 is designed such that at no time does the deadbolt (not shown) touch the metal face of the striker plate. However, once the deadbolt has penetrated the striker plate 70, the deadbolt will contact the inner edge 82 of the metal striker plate on either side of the damper 72 so as not to compromise safety and security.

The gap between a door and the doorframe must be present and is intended to account for variations and installation and environmental factors like temperature changes. Accordingly, the gap between the door and the doorframe cannot be closed with a nonmoving component as this might inadvertently generate a situation where the door would not close properly under certain conditions. Accordingly, the damper of the present invention is designed as a mating part for the automatically deploying deadbolt which is spring-loaded in a direction opposite that in which the deadbolt is spring-loaded. The damper 72 is designed to initially completely eliminate the gap between the door and the doorframe by contacting the leading edge of the door as a disclosing. Since the damper 72 is spring-loaded, as the leading edge of the door touches damper, the damper is caused to be pushed into the cut out 74 in the striker plate. As the spring-loaded automatic deadbolt is released, the deadbolt is now in contact with the damper 72 and the deadbolt spring overwhelms the damper spring 78 flexing the damper 72 away from the door edge and into the recess or cut out 74 in the striker plate so that the deadbolt can ultimately attain the position it needs to be in order to properly penetrate the striker plate 70. For safety and security reasons, the damper spring 78 will be tuned to slow the motion of the deadbolt deploying while at the same time not preventing it from extending fully into the striker plate. It should be noted that the damper 72 according to the present invention is not a true damper since damping implies a resistive force that is proportional to speed and generally requires some fluid component. Rather, the damper 72 the present invention is a device and method to better control the advance of the automatically deploying deadbolt by bringing to bear an opposing, but lighter, force and the one that is being applied to the deadbolt to deploy it.

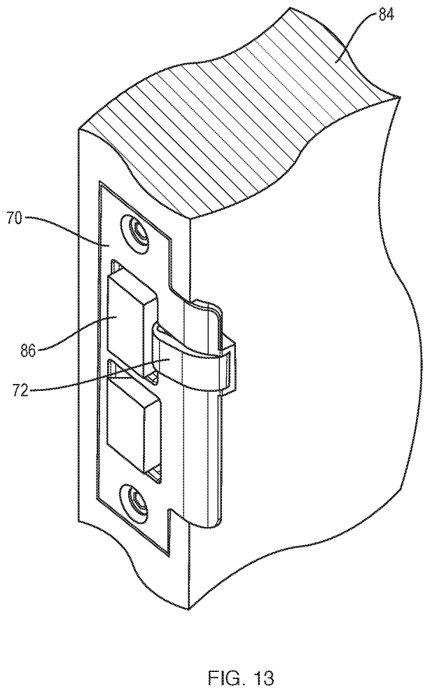

FIG. 13 is a cut away view of a doorframe he 84 showing the striker plate 70 with automatically deploying deadbolt damper 72 and deadbolt 86 in place.

It is important to note that the present invention is not intended to be limited to a system or method which must satisfy one or more of any stated objects or features of the invention. It is also important to note that the present invention is not limited to the preferred, exemplary, or primary embodiment(s) described herein.

Modifications and substitutions by one of ordinary skill in the art are considered to be within the scope of the present invention, which is not to be limited except by the allowed claims and any legal equivalents thereto.

The invention claimed is:

1. A door closure noise dampening system, comprising:
a door mounted noise dampening closure portion;
a doorframe mounted noise dampening closure portion, said doorframe mounted noise dampening closure portion configured for receiving a portion of said door mounted noise dampening closure portion; and
a doorframe mounted striker plate portion, configured for receiving a door mounted door lock latch.

2. The door closure noise dampening system of claim 1, wherein said door mounted noise dampening closure portion includes a pivotable arm portion, said pivotable arm portion movable between a first armed position in which said pivotable arm portion is configured for coming into contact with said doorframe mounted noise dampening closure portion, and a second engaged position, configured for engaging with said doorframe mounted noise dampening closure portion.

3. The door closure noise dampening system of claim 2, wherein said pivotable arm portion includes a rotatable element disposed on a distal end of said pivotable arm portion.

4. The door closure noise dampening system of claim 3, wherein said proximal end of said pivotable arm portion of said door mounted noise dampening closure portion is coupled to a piston.

5. The door closure noise dampening system of claim 4, wherein said a doorframe mounted noise dampening closure portion includes a first tab and a second tab generally parallel to said first tab, said first tab configured for engaging with said rotatable element disposed on said distal end of said pivotable arm portion for causing the piston coupled to said proximal end of said pivotable arm portion to move from said armed position to said engaged position by causing said rotatable element to travel upward along said first tab in a controlled manner when a door on which said door mounted noise dampening closure portion is mounted is moved from a first open position to a second closed position, and wherein said second tab is configured for engaging with said rotatable element when said door on which said door mounted noise dampening closure portion is mounted is moved from said second closed position to said first open position thereby causing said pivotable arm portion to move from said second engaged position to said first armed position.

6. The door closure noise dampening system of claim 1, wherein said doorframe mounted striker plate portion includes a striker plate damper element, movable from a first at rest position to a second engaged position upon pressure of a door lock latch engaging with said striker plate damper element, and wherein said striker plate damper element is coupled to a spring configured for providing resistance of movement of said striker plate damper element from said at rest position to said engaged position.

7. A door closure dampening system for a door having an automatically deployable deadbolt lock, said automatically deployable deadbolt lock configured for being deployed automatically when a leading edge of said door is in close proximity to a doorframe, said door closure dampening system comprising:
a doorframe mounted striker plate portion, configured for receiving a door mounted automatically deploying deadbolt lock, wherein said doorframe mounted striker plate portion includes a deadbolt damper element movable from a first at rest position to a second engaged position upon pressure by said leading edge of said door engaging with said damper element, wherein said first at rest position of said deadbolt damper element is configured for providing an engagement surface which protrudes from the generally plainer surface of the remainder of the striker plate, and wherein said automatically deployable deadbolt lock damper element is coupled to a spring, configured for providing controlled movement of said automatically deployable deadbolt resistance of movement of said automatically deployable deadbolt damper element from said at rest position to said engaged position.

8. A door closure dampening system for a door having an automatically deployable deadbolt lock, said automatically deployable deadbolt lock configured for being deployed automatically when a leading edge of said door is in close proximity to a doorframe, said door closure dampening system comprising:
a door mounted noise dampening closure portion, wherein said door mounted noise dampening closure portion includes a pivotable arm portion, said pivotable arm portion movable between a first armed position in which said pivotable arm portion is configured for coming into contact with a doorframe mounted noise dampening closure portion, and a second engaged position, configured for engaging with said doorframe mounted noise dampening closure portion, wherein said pivotable arm portion includes a rotatable element disposed on a distal end of said pivotable arm portion, and wherein said proximal end of said pivotable arm portion of said door mounted noise dampening closure portion is coupled to a piston;
said doorframe mounted noise dampening closure portion configured for receiving a portion of said door mounted noise dampening closure portion, and wherein said doorframe mounted noise dampening closure portion includes a first tab and a second tab generally parallel to said first tab, said first tab configured for engaging with said rotatable element disposed on said distal end of said pivotable arm portion for causing the piston coupled to said proximal end of said pivotable arm portion to move from said armed position to said engaged position by causing said rotatable element to travel upward along said first tab in a controlled manner when a door on which said door mounted noise dampening closure portion is mounted is moved from a first open position to a second closed position, and wherein said second tab is configured for engaging with said rotatable element when said door on which said door mounted noise dampening closure portion is mounted is moved from said second closed position to said first open position thereby causing said pivotable arm portion to move from said second engaged position to said first armed position; and
a doorframe mounted striker plate portion, configured for receiving a door mounted automatically deploying deadbolt lock, wherein said doorframe mounted striker plate portion includes a deadbolt damper element movable from a first at rest position to a second engaged position upon pressure by said leading edge of said door engaging with said damper element, wherein said first at rest position of said deadbolt damper element is configured for providing an engagement surface which protrudes from the generally plainer surface of the remainder of the striker plate, and wherein said automatically deployable deadbolt lock damper element is coupled to a spring, configured for providing controlled movement of said automatically deployable deadbolt resistance of movement of said automatically deployable deadbolt damper element from said at rest position to said engaged position.
